(19) United States
(12) Patent Application Publication
(10) Pub. No.: US 2013/0297331 A1
(43) Pub. Date: Nov. 7, 2013

(54) Medical Imaging Guideline Compliance System

(71) Applicants: Sven Zuehlsdorff, Westmont, IL (US); Christopher Glielmi, Hoboken, NJ (US); Ning Jin, Powell, OH (US); Xiaoming Bi, Aurora, IL (US); Jens Gühring, Erlangen (DE)

(72) Inventors: Sven Zuehlsdorff, Westmont, IL (US); Christopher Glielmi, Hoboken, NJ (US); Ning Jin, Powell, OH (US); Xiaoming Bi, Aurora, IL (US); Jens Gühring, Erlangen (DE)

(73) Assignees: Siemens Aktiengesellschaft, Munchen (DE); Siemens Medical Solutions USA, Inc., Malvern, PA (US)

(21) Appl. No.: 13/756,928

(22) Filed: Feb. 1, 2013

Related U.S. Application Data
(60) Provisional application No. 61/640,755, filed on May 1, 2012.

(51) Int. Cl. G06Q 40/08; G06Q 50/22

(52) U.S. Cl. CPC G06Q 40/08; G06Q 50/22
USPC 705/2

(57) ABSTRACT

A system supports medical imaging compliance with guideline and reimbursement requirements using at least one repository and a compliance processor. The at least one repository associates information including, specific reimbursement requirements of a patient insurance company with an imaging protocol compliant with predetermined guidelines for imaging a particular anatomical feature and with a specific type of imaging device and with multiple different steps of the imaging protocol. The compliance processor uses the information in, determining whether a particular imaging protocol for imaging a particular anatomical feature of a particular patient on a particular type of imaging device is compliant with the guidelines and the reimbursement requirements and identifying at least one of, (a) a missing step and (b) an incorrect step, in the particular imaging protocol.

This is a non-provisional application of provisional application Ser. No. 61/640,755 filed May 1, 2012, by S. Zuehlsdorff et al.

### FIELD OF THE INVENTION

This invention concerns a system supporting patient specific and imaging device specific medical imaging and imaging protocol compliance with guideline and reimbursement requirements.

### BACKGROUND OF THE INVENTION

In diagnostic medical imaging, there are several bodies of professional interest groups that typically define guidelines for medical, surgical and diagnostic procedures. Multiple organizations provide appropriateness criteria for cardiac computed tomography (CCT) and cardiovascular magnetic resonance (CMR) imaging for a wealth of cardiovascular diseases, e.g. coronary artery diseases and non-ischemic cardiomyopathies. The appropriateness criteria represent the state of the art and current knowledge in diagnostic imaging. Often, payers such as health insurance organizations follow those guidelines to derive payment strategies. One payment strategy is reflected by the Current Procedural Terminology (CPT) codes that are maintained by the American Medical Association. The CPT code set describes medical, surgical, and diagnostic services and is designed to promote exchange of uniform information about medical services and procedures between physicians, coders, patients, accreditation organizations, and payers for administrative, financial, and analytical purposes. Also, imaging modality specific organizations (e.g. the Society for Cardiovascular Magnetic Resonance, SCMR) derive recommendations for imaging protocols that are adopted by manufacturers.

However, in clinical practice, utilized imaging protocols vary across hospitals and standardization is not common practice often resulting in varying image quality across imaging centers and hospitals. Furthermore, the translation of CPT codes for association with specific imaging protocols is inconsistent and payment guidelines vary from payer to payer. This often results in a labor and cost intensive process of obtaining pre-authorization for certain procedures. A system according to invention principles addresses these deficiencies and associated problems.

### SUMMARY OF THE INVENTION

A system provides image scanning compliant with clinical and technical requirements for medical imaging and with criteria for medical reimbursement policies. A system supports patient specific and imaging device specific medical imaging compliance with guideline and reimbursement requirements using at least one repository and a compliance processor. The at least one repository associates information including, specific reimbursement requirements of a patient insurance company with an imaging protocol compliant with predetermined guidelines for imaging a particular anatomical feature and with a specific type of imaging device and with multiple different steps of the imaging protocol. The compliance processor uses the information in, determining whether a particular imaging protocol for imaging a particular anatomical feature of a particular patient on a particular type of imaging device is compliant with the guidelines and the reimbursement requirements and identifying at least one of, (a) a missing step and (b) an incorrect step, in the particular imaging protocol.

### BRIEF DESCRIPTION OF THE DRAWING

FIG. 1 shows a system supporting patient specific and imaging device specific medical imaging compliance with guideline and reimbursement requirements, according to invention principles.

FIG. 2 shows a Table of MR guidelines and protocols associating recommended imaging protocols for a specific condition (e.g. acute myocardial infarction) with corresponding CPT codes and with guidelines for detection and correction of missing steps, according to invention principles.

FIG. 3 shows a process for performing an imaging examination and indicating tasks to achieve compliance and meet required guidelines at different stages of the process, according to invention principles.

FIG. 4 shows a flowchart of a process used for supporting patient specific and imaging device specific medical imaging compliance with guideline and reimbursement requirements, according to invention principles.

### DETAILED DESCRIPTION OF THE INVENTION

A system facilitates standardization of imaging protocols, monitors an imaging process to ensure compliance with payment guidelines and regulations whilst maintaining consistent standards of care. The system supports appropriate use of medical imaging for patient benefit, reduced need for pre-authorization and administrative resources caused by unregulated practices, and increases efficiency in reimbursement for health care providers. The system ensures standardization of imaging protocols that comply with regulations, guidelines and standards of care.

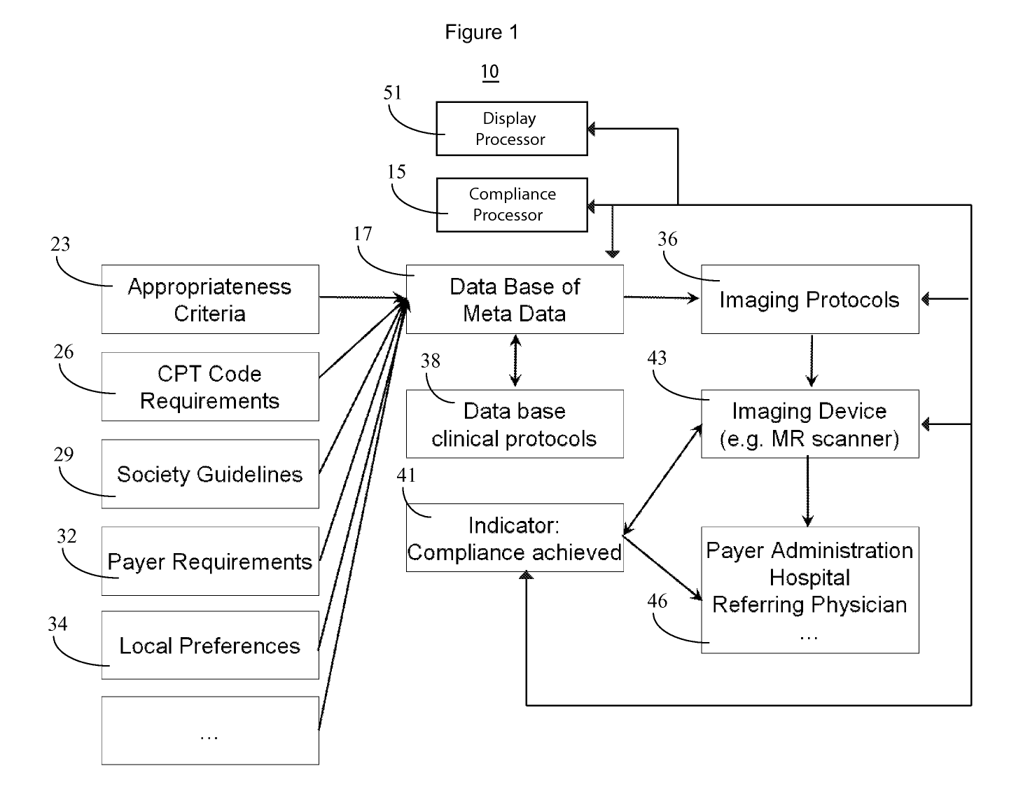

FIG. 1 shows system 10 supporting patient specific and imaging device specific medical imaging compliance with guideline and reimbursement requirements. At least one repository 17 (e.g., a database) of information associates, specific reimbursement requirements 32 of a patient insurance company with an imaging protocol of protocols 36 compliant with predetermined guidelines for imaging a particular anatomical feature and with a specific type of imaging device 43 and with multiple different steps of the imaging protocol. Compliance processor 15 uses the information in, determining whether a particular imaging protocol of protocols 36 for imaging a particular anatomical feature of a particular patient on a particular type of imaging device is compliant with the guidelines and the reimbursement requirements 32 and identifying at least one of, (a) a missing step and (b) an incorrect step, in the particular imaging protocol. In response to determining a particular imaging protocol is compliant with the guidelines, compliance processor 15 generates a compliance indicator 41 which is communicated to a payer and to a hospital (e.g. a referring physician) 46 as well as imaging device 43.

At least one repository 17 includes Meta data that contains current active relevant regulations from different bodies of professional interest groups and other organizations and a database of clinical diagnosis and treatment protocols 38. Repository 17 also includes, appropriateness criteria 23, CPT (Current Procedural Terminology) Code requirements 26, society, expert group and other guidelines 29, payer reimbursement requirements 32 and local preferences 34. System 10 employs methods to determine local/site specific rules 34 instead of or as well as other relevant regulations and derives imaging protocols for individual imaging device 43 and a clinical indication 41 of compliance with guidelines and regulations in repository 17. Compliance processor 15 prevents imaging and processing steps that are not appropriate according to relevant rules and guidelines and provides indicator 41 showing current status and progress of an ongoing imaging examination and lists missing steps to achieve compliance and meet required guidelines. Display processor 51 generates data representing an image including a bar showing indicators, alerts and progress of an imaging study and indicating how many scans or time is remaining, for example.

Appropriateness criteria 23 include relevant rules and regulations of different bodies of professional interest groups, modalities and clinical indications. For example, for a selected clinical application comprising Cardiovascular magnetic resonance (CMR) imaging, relevant appropriateness criteria rules and regulation in CMR involve the detection of myocardial scar and viability and evaluation of myocardial scar using Late Gadolinium Enhancement (LGE). For stress perfusion CMR, a Vasodilator is considered inappropriate to evaluate a chest pain syndrome if the patient has low probability of coronary artery disease (CAD), an interpretable ECG and is able to exercise. Other rules include Society for Cardiovascular Magnetic Resonance (SCMR) guidelines, for example. For analysis of left ventricular function SCMR recommends, specific image contrast (Steady State Free Precession), specific slice orientations (e.g. horizontal long axis view), slice thickness (6-8 mm), temporal resolution (≦45 ms) and other critical imaging parameters as well as optional recommendations. This data is used to derive manufacturer and modality specific imaging protocols.

Current Procedural Terminology (CPT) code requirements 26 describe current medical and imaging procedures. Specifically, CMR relevant codes include CPT 75557 for morphology and function, without contrast, CPT 75559 for morphology and function with stress imaging, CPT 75561 for morphology and function without contrast, followed by contrast and further sequences, CPT 75563 for morphology and function with contrast and stress imaging CPT 75565 for flow quantification (add on), for example.

Appropriateness criteria 23, society, expert group and other guidelines 29 and payer reimbursement requirements 32 includes rules, guidelines, consensus and requirements for relevant bodies of professional groups and other organizations. Data repository 17 is accessible via the Internet, interrogated to retrieve specific rules and is updated automatically at intermittent time intervals in response to changes in underlying guidelines. Data in repository 17 covers multiple different imaging modalities (including, MR, CT, X-Ray, Ultrasound) and in one embodiment is manufacturer independent and specific imaging device independent

Compliance processor 15 employs a feedback process indicating completeness of a finished imaging study and associated appropriateness criteria 23, guidelines and CPT codes 26. Processor 15 provides confirmation to insurance companies that imaging examination protocols are compliant, therefore reducing need for administrative resources. Further, processor 15 prompts a user for input if required by a decision making process and manages different profiles that combine multiple settings for specific uses as an alternative to automatic determination of an adequate set of rules for privately insured patients or patients with arrhythmia, for example. Processor 15 also checks for pre-requisites to be met, e.g., to ensure a certain MR RF imaging coil is used, for example.

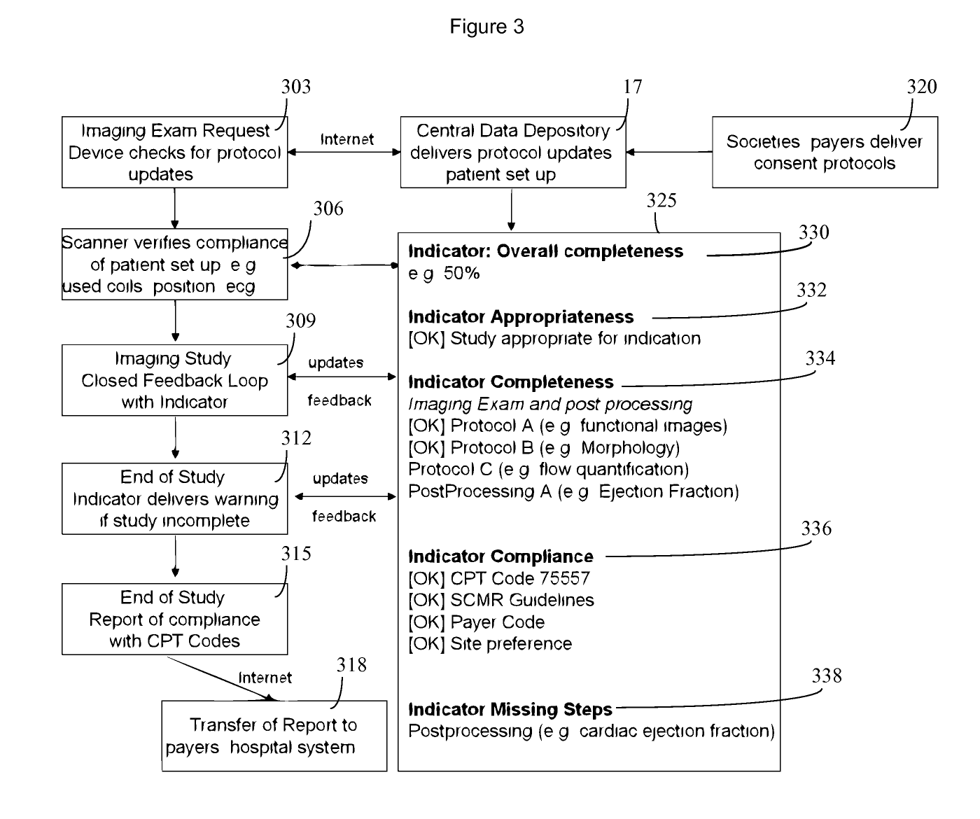

FIG. 3 shows a process for performing an imaging examination and indicating tasks performed by compliance processor 15 (FIG. 1) to achieve compliance and meet required guidelines at different stages of the process. In step 303, in response to an imaging examination request, processor 15 checks for imaging protocol updates and rules and guidelines 320 (including appropriateness criteria 23, CPT (Code requirements 26, society, expert group and other guidelines 29, payer reimbursement requirements 32 and local preferences 34) by interrogating central repository 17. Processor 15 derives specific imaging protocols using guidelines 320 stored in the data repository 17 for CAD (Detection of Coronary Artery Disease), for example. The guidelines indicate use of vasodilator Perfusion MRI is appropriate for the imaging examination and a specific CPT code applies, for example. The SCMR guidelines include recommendations with respect to spatial and temporal resolution, imaging contrast, and injection protocol of contrast agents and processor 15 derives specific imaging protocols that comply with the recommendations. For example, on a Siemens scanner, the system recommends for left ventricular function use of image contrast SSFP (Steady state free precession), temporal resolution less than or equal to 45 ms, for example, that results in a segmented, retro-gated TrueFISP (True fast imaging with steady state precession) cine protocol that uses a low number of segments per heartbeat to comply with desired temporal resolution. Processor 15 automatically derives these imaging protocols using repository 17 of proven clinical protocols. In an additional step, imaging protocols are added that conform with local preferences 34 of a hospital or referring physician and the imaging protocols are made available to a scanner via a network connection.

In step 306, compliance processor 15 verifies compliance of a candidate particular imaging protocol and a patient set up including, type of RF coils patient position and ECG trigger, for imaging a particular anatomical feature of a particular patient on a particular type of imaging device. Specifically, processor 15 verifies compliance with guidelines 320 and identifies at least one of, (a) a missing step and (b) an incorrect step, in the particular imaging protocol and provides indicators 325. Indicators 325 show current status and progress of an ongoing imaging examination. One embodiment includes a user interface comprising a field providing information showing overall progress 330 (e.g., 50 percent complete) of the study in a progress bar that describes how many scans or time is remaining and an indicator if full compliance with the guidelines is achieved, for example. Processor 15 provides other indicators in response to checks to indicate appropriateness 332 of an imaging study, completeness of imaging protocol steps 334, compliance with CPT codes and guidelines 336 and an indicator identifying missing steps 338.

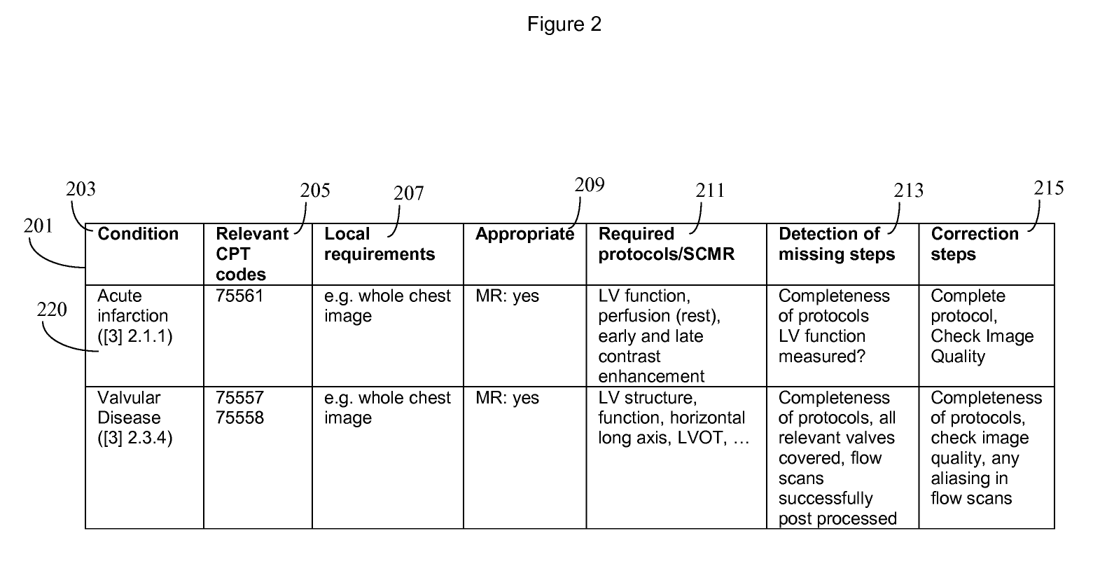

In one embodiment, processor 15 verifies compliance with guidelines 320 using a lookup table. FIG. 2 shows lookup Table 201 of exemplary MR guidelines and protocols associating a specific condition (e.g. acute myocardial infarction) with corresponding CPT codes and with imaging protocol guidelines for detection and correction of missing steps. Processor 15 uses row 220, for example, to verify a candidate particular imaging protocol and a patient set up including, type of RF coils patient position, ECG trigger, for acute myocardial infarction imaging 203, is compliant with CPT codes 205, local requirements (acquiring a whole chest image) 207, appropriateness of MR imaging 209, protocol suitability with SCMR guidelines for left ventricle (LV) function perfusion and early and late contrast enhancement 211, detection of missing steps (completeness of LV measurement) 213 and correction steps 215 (by completion of imaging steps and checking image quality). The recommended imaging protocols 211 for a specific condition 203 (e.g. acute myocardial infarction) are derived from a consensus document of a relevant professional organization. Corresponding CPT codes 205 are associated with the protocols. A detection metric 213 for detecting missing steps includes completeness of recommended protocols and enable identification of missing post processing steps (e.g. flow quantified, ejection fraction determination) by comparison of performed steps with predetermined steps indicated in guidelines). Related image correction steps 215 are also indicated. Image quality is validated in suggested post processing missing steps in a fully automated fashion or a user interactive manner.

Processor 15 provides indicators 325 as feedback in step 309 indicating completeness of a finished study and compliance with associated appropriateness criteria, guidelines and CPT codes. The feedback function of processor 15 provides alerts of missing steps or lack of completion of an imaging study and in one embodiment automatically triggers performance of missing steps, in response to, determined lack of completeness of imaging protocols according to guidelines, lack of completeness of post processing steps (e.g. calculation of cardiac ejection fraction) and consistency with recommended parameters. During an imaging scan, processor 15 provides indicators 325 identifying the compliance status and progress of a scan. Processor 15 ensures necessary imaging protocols are executed in a complete and accurate fashion providing a desired standard of care. This facilitates ensuring use of the proper standard of care as well as meeting requirements for payment reimbursement.

In step 312, upon completion of an imaging study, processor 15 performs basic image quality checks (e.g., to determine aliasing is avoided in MR flow measurements) and performs an image quality assessment (manual or automatic) and provides a warning if an imaging examination is incomplete. Processor 15 in step 315 provides confirmation for insurance companies that an imaging examination protocol is compliant with regulations, guidelines and recommendations thereby reducing need for administrative resources. In response to completion of an imaging study, processor 15 generates a report indicating compliance with CPT Codes, SCMR guidelines, appropriateness and local and site preferences, for example. A completed imaging study is stored as DICOM compatible images and is included in a report provided to a referring physician or payer such as a health insurance company. The report contains relevant protocols and guidelines and codes associated with a protocol in order to streamline processing of claims, payments and required approvals. Processor 15 communicates the report to reimbursement claim payer organizations, a hospital system, a patient record, a referring physician and insurance companies, for example, in step 318.

System 10 (FIG. 1) and compliance processor 15 processes an imaging examination by acquisition and update of insurance reimbursement and guideline data by communication with data sources. Processor 15 selects an imaging protocol, verifies the selected protocol is compliant with guidelines, patient specific reimbursement requirements and a specific imaging device (including specific features e.g., an RF coil) to be used. The system detects a missing step during the examination in response to guidelines, patient specific reimbursement requirements and specific imaging device to be used and prompts a user with a corrected step and warnings during the examination. The system also selects and outputs appropriate reimbursement codes (e.g. CPT codes). Processor 15 employs repository 17. e.g. including lookup tables, associating, (a) patient specific characteristics, age gender, height weight, medical conditions medications, (b) specific reimbursement requirements of a patient insurance company and CPT and ICD9 codes, for example, (c) specific types of imaging device features, (d) local rules and other regulations, (e) imaging protocols supported by the device, and compliant with database 320 requirements, (f) multiple different steps of imaging protocols and (g) performance measures for verifying an image meets requirements.

An imaging protocol is a particular sequence of operations performed by an imaging system in acquiring images of a patient anatomical region. Central data repository 17 (FIG. 1) stores a comprehensive set of imaging protocols for each medical imaging examination indication and scanner type. The repository includes Meta data that associates an indication with required imaging methods. System 10 derives imaging protocols for an individual imaging device and clinical indication in compliance with guidelines and regulations in repository 17. Typically, a patient has a certain, well documented condition and an appropriate imaging modality is used for an imaging study. For illustration, the use of MR is deemed appropriate to measure LV function and detection of myocardial scar. SCMR guidelines indicate a list of recommended protocols (e.g. LV function and structure, first pass perfusion, early and late gadolinium enhancement). Furthermore, specific requirements are defined that are imaging device manufacturer independent. For instance, guidelines recommend functional cardiac MR imaging. This includes a steady state free precession readout pulse sequence, slice thickness and temporal resolution parameters. The guidelines are translated into manufacturer and scanner specific protocols in a manual fashion or an automated fashion by system 10. In one embodiment, the system employs a cardiac Dot engine. One user interface parameter is “Breath Hold” and imaging protocol settings (e.g. number of segments, temporal and spatial resolution) are optimized in accordance with recommended guidelines for the breath hold parameter.

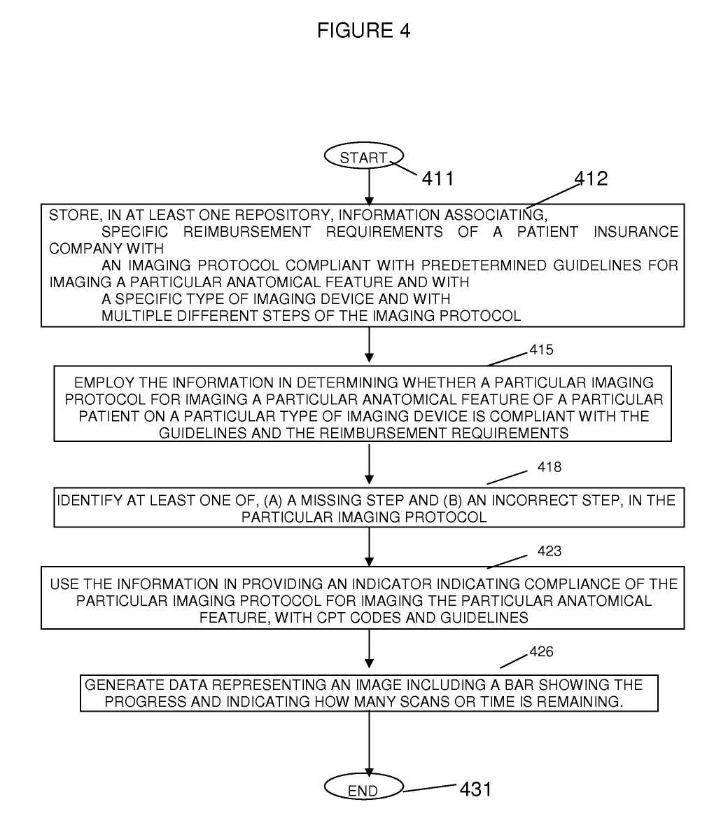

FIG. 4 shows a flowchart of a process used by system 10 (FIG. 1) for supporting patient specific and imaging device specific medical imaging compliance with guideline and reimbursement requirements. In step 412, following the start at step 411, compliance processor 15 (FIG. 1) stores, in at least one repository 17, information associating, specific reimbursement requirements of a patient insurance company with an imaging protocol compliant with predetermined guidelines for imaging a particular anatomical feature and with a specific type of imaging device and with multiple different steps of the imaging protocol. The information also associates the imaging protocol with patient specific characteristics including age, gender, height, weight, medical conditions and medications and with specific reimbursement requirements of a patient insurance company including at least one of CPT, and ICD9 codes. The information also associates the imaging protocol with features of the specific type of imaging device, local rules and regulations concerning imaging and with performance measures for verifying an image meets requirements.

In step 415 processor 15 employs the information in determining whether a particular imaging protocol for imaging a particular anatomical feature of a particular patient on a particular type of imaging device is compliant with the guidelines and the reimbursement requirements. Processor 15 determines whether the particular imaging protocol and at least one of, (a) type of RF coils, (b) patient position and (c) a type of ECG trigger, (d) temporal resolution, (e) spatial resolution, (f) use of contrast agent, (g) timing and (h) whether a fat suppression imaging protocol is used, are compliant with the guidelines and the reimbursement requirements. In step 418, processor 15 identifies at least one of, (i) a missing step and (ii) an incorrect step, in the particular imaging protocol and automatically initiates performance of missing steps, in response to at least one of, (a) determined lack of completeness of imaging protocols and (b) determined lack of completeness of image post-processing steps. In step 423, processor 15 uses the information in providing indicators indicating appropriateness of the particular imaging protocol for imaging the particular anatomical feature and indicating compliance of the particular imaging protocol for imaging the particular anatomical feature, with CPT codes and guidelines. The indicators also indicate current status and progress of an imaging examination using the particular imaging protocol for imaging the particular anatomical feature. Processor 15 in step 426 generates data representing an image including a bar showing the progress and indicating how many scans or time is remaining. The process of FIG. 4 terminates at step 431.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of the FIGS. 1-4 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system verifies compliance of a candidate particular imaging protocol and a patient set up for imaging a particular anatomical feature of a particular patient on a particular type of imaging device and identifies a missing step and an incorrect step. Further, the processes and applications may, in alternative embodiments, be located on one or more (e.g., distributed) processing devices on a network linking the units of FIG. 1. Any of the functions and steps provided in FIGS. 1-4 may be implemented in hardware, software or a combination of both. No claim element herein is to be construed under the provisions of 35 U.S.C. 112, sixth paragraph, unless the element is expressly recited using the phrase “means for.”

What is claimed is:

1. A system supporting patient specific and imaging device specific medical imaging compliance with guideline and reimbursement requirements, comprising:
at least one repository of information associating,
specific reimbursement requirements of a patient insurance company with
an imaging protocol compliant with predetermined guidelines for imaging a particular anatomical feature and with
a specific type of imaging device and with
a plurality of different steps of said imaging protocol;
a compliance processor for using said information in,
determining whether a particular imaging protocol for imaging a particular anatomical feature of a particular patient on a particular type of imaging device is compliant with said guidelines and said reimbursement requirements and identifying at least one of,
(a) a missing step and
(b) an incorrect step, in said particular imaging protocol.

2. A system according to claim 1, wherein
said information also associates said imaging protocol with
a specific type of imaging device and with
a plurality of different steps of said imaging protocol and with
patient specific characteristics including age gender, height weight, medical conditions and medications.

3. A system according to claim 1, wherein
said information also associates said imaging protocol with
specific reimbursement requirements of a patient insurance company including at least one of CPT, and ICD9 codes.

4. A system according to claim 1, wherein
said information also associates said imaging protocol with
features of said specific type of imaging device.

5. A system according to claim 1, wherein
said information also associates said imaging protocol with
local rules and regulations concerning imaging.

6. A system according to claim 1, wherein
said information also associates said imaging protocol with
performance measures for verifying an image meets requirements.

7. A system according to claim 1, wherein
said compliance processor determines whether said particular imaging protocol and at least one of, (a) type of RF coils, (b) patient position and (c) a type of ECG trigger, (d) temporal resolution, (e) spatial resolution, (f) use of contrast agent, (g) timing and (h) whether a fat suppression imaging protocol is used, are compliant with said guidelines and said reimbursement requirements.

8. A system according to claim 1, wherein
said compliance processor uses said information in providing an indicator indicating appropriateness of said particular imaging protocol for imaging said particular anatomical feature.

9. A system according to claim 1, wherein
said compliance processor uses said information in providing an indicator indicating compliance of said particular imaging protocol for imaging said particular anatomical feature, with CPT codes and guidelines.

10. A system according to claim 1, wherein
said compliance processor uses said information in providing an indicator indicating current status and progress of an imaging examination using said particular imaging protocol for imaging said particular anatomical feature.

11. A system according to claim 10, including
a display processor for generating data representing an image including a bar showing said progress and indicating how many scans or time is remaining.

12. A system according to claim 1, wherein
said compliance processor automatically initiates performance of missing steps, in response to at least one of, (a) determined lack of completeness of imaging protocols and (b) determined lack of completeness of image post-processing steps.

13. A method supporting patient specific and imaging device specific medical imaging compliance with guideline and reimbursement requirements, comprising the activities of:
storing, in at least one repository, information associating,
specific reimbursement requirements of a patient insurance company with
an imaging protocol compliant with predetermined guidelines for imaging a particular anatomical feature and with
a specific type of imaging device and with
a plurality of different steps of said imaging protocol;
employing said information in determining whether a particular imaging protocol for imaging a particular anatomical feature of a particular patient on a particular type of imaging device is compliant with said guidelines and said reimbursement requirements and identifying at least one of,
(a) a missing step and
(b) an incorrect step, in said particular imaging protocol.

14. A method according to claim 13, wherein
said information also associates said imaging protocol with
patient specific characteristics including age gender, height weight, medical conditions and medications.

15. A method according to claim 13, wherein
said information also associates said imaging protocol with
specific reimbursement requirements of a patient insurance company including at least one of CPT, and ICD9 codes and with
features of said specific type of imaging device.

16. A method according to claim 13, wherein
said information also associates said imaging protocol with
local rules and regulations concerning imaging and with
performance measures for verifying an image meets requirements.

17. A method according to claim 13, including the activity of
determining whether said particular imaging protocol and at least one of, (a) type of RF coils, (b) patient position and (c) a type of ECG trigger are compliant with said guidelines and said reimbursement requirements.

18. A method according to claim 13, including the activity of
using said information in providing an indicator indicating appropriateness of said particular imaging protocol for imaging said particular anatomical feature.

19. A method according to claim 13, including the activity of
using said information in providing an indicator indicating compliance of said particular imaging protocol for imaging said particular anatomical feature, with CPT codes and guidelines.

20. A method according to claim 13, including the activity of
using said information in providing an indicator indicating current status and progress of an imaging examination using said particular imaging protocol for imaging said particular anatomical feature.

21. A method according to claim 20, including the activity of
generating data representing an image including a bar showing said progress and indicating how many scans or time is remaining.

22. A method according to claim 13, including the activity of
automatically initiating performance of missing steps, in response to at least one of, (a) determined lack of completeness of imaging protocols and (b) determined lack of completeness of image post-processing steps.
